(19) United States
(12) Patent Application Publication
(10) Pub. No.: US 2025/0199832 A1
(43) Pub. Date: Jun. 19, 2025

(54) ISOLATING DRIVERS USING VIRTUALIZATION IN A MONOLITHIC OPERATING SYSTEM

(71) Applicant: Red Hat, Inc., Raleigh, NC (US)

(72) Inventors: Alberto Ruiz, Madrid (ES); Francisco Martinez, Barcelona (ES)

(21) Appl. No.: 18/538,077

(22) Filed: Dec. 13, 2023

(51) Int. Cl. G06F 9/455

(52) U.S. Cl. CPC G06F 9/45558

(57) ABSTRACT

Virtualization can be used to isolate drivers in monolithic operating systems. For example, a monolithic kernel can determine that a first driver has a first level of criticality to the monolithic kernel that is higher than a second level of criticality for a second driver. In response to determining that the first level is higher than the second level, the monolithic kernel can execute a first driver workload for the first driver. The monolithic kernel can also execute a virtual machine including a guest kernel. The guest kernel can execute a second driver workload for the second driver such that the second driver is isolated to the virtual machine. A communication channel can be generated between the guest kernel and the monolithic kernel such that the monolithic kernel can access the second driver workload via the communication channel.

### TECHNICAL FIELD

The present disclosure relates generally to monolithic operating systems. More specifically, but not by way of limitation, this disclosure relates to isolating drivers using virtualization in monolithic operating systems.

### BACKGROUND

Virtualization may be used to provide some physical components as logical objects in order to allow running various software modules, concurrently and in isolation from other software modules, on a computing device or a collection of connected computing devices. Virtualization may allow, for example, for consolidating multiple physical servers into one physical server running multiple guest virtual machines in order to improve the hardware utilization rate. A virtual machine can be a substantially isolated environment that has its own operating system, software applications, and virtualized hardware. For example, a virtual machine can have a virtual Central Processing Unit (vCPU), a virtual Random Access Memory (vRAM), and other components.

### BRIEF DESCRIPTION OF THE DRAWINGS

FIG. 1 is a block diagram of an example of a monolithic operating system for isolating drivers using virtualization according to some aspects of the present disclosure.

FIG. 2 is a flow diagram of an example of a monolithic operating system for isolating drivers using virtualization according to some aspects of the present disclosure.

FIG. 3 is a block diagram of an example of an automotive computing environment with a monolithic kernel architecture that isolates drivers using virtualization according to some aspects of the present disclosure.

FIG. 4 is a block diagram of another example of a monolithic operating system for isolating drivers using virtualization according to some aspects of the present disclosure.

FIG. 5 is a flow chart of an example of a process for isolating drivers using virtualization in a monolithic operating system according to some aspects of the present disclosure.

### DETAILED DESCRIPTION

In some computing systems, such as automotive computing systems, resources may be shared among drivers with different levels of criticality to the computing system. Because resources may be shared, drivers with lower criticality levels may potentially interfere with drivers or services with higher criticality levels. For instance, automotive computing systems (e.g., that include an ISO 26262 certified operating system) may use drivers with different risk classification ratings, such as Quality Management level drivers and various Automotive Safety Integrity Level (ASIL) level drivers. Failure of QM level drivers may involve relatively lower risk (e.g., to a user of a car executing the automotive computing system) than failure of ASIL level drivers. In a monolithic kernel, all drivers may execute in a single address space, with each driver having the same privilege execution. Thus, failure of one driver (e.g., a lower criticality level driver) may propagate to other, more critical drivers, or in some cases to the entire monolithic kernel.

To avoid compromising the entire kernel, conventional techniques can involve using microkernel architecture instead of monolithic kernel architecture to isolate different drivers. But microkernel architecture may have limitations compared to monolithic kernel architecture, such as reduced performance and increased latency due to frequent communication between the kernel and user-level processes. Microkernel architecture may additionally lead to increased operating system complexity, which may be more difficult to develop or maintain compared to monolithic kernel architecture.

Some examples of the present disclosure can overcome one or more of the abovementioned problems by using virtualization to isolate lower criticality drivers in a computing system with a monolithic kernel. For example, device ownership for lower criticality drivers can be passed through to a virtual machine that is executing a guest monolithic kernel. By moving workloads that use the lower criticality drivers can be moved to the virtual machine, fatal error propagation can be isolated to processes inside the virtual machine without the use of microkernel architecture. Further, monolithic kernel architecture can provide greater flexibility and improved computing performance in many computing systems, including automotive computing systems, compared to microkernel architecture. As automotive vehicles may include multiple automotive computing systems, embodiments described herein may allow for combining computing systems to execute drivers with different criticality levels, as opposed to requiring separate computing systems for each criticality level or systems with microkernel architecture.

In a particular example, an automotive computing system can include device drivers used to perform different functions for an automotive vehicle. The automotive computing system may include a kernel architecture operating system. Each driver may have an ASIL classification indicating the criticality level (e.g., failure impact on the computing system or the user operating the automotive vehicle) for the respective driver. ASIL D classifications may indicate a highest criticality, involving important functions such as wheel braking. ASIL C classifications can involve functions such as cruise control, ASIL B can involve functions such as headlights and brake lights, ASIL A may involve functions such as taillights, and a QM classification may indicate a lowest criticality for the computing system, such as dashboard lights.

In this example, the automotive computing system can execute a headlight driver with an ASIL B classification and a dashboard light driver with a QM classification. Because the headlight driver has a higher criticality level to the automotive computing system than the dashboard light driver, it may be beneficial to isolate the dashboard light driver from the headlight driver in the kernel space. That way, if the dashboard light driver fails (e.g., causing the dashboard lights in the automotive vehicle to fail), the headlights may still be operable because the dashboard light driver is isolated from the rest of the kernel space. Therefore, a monolithic kernel (e.g., host kernel) for the automotive system can isolate the dashboard light driver to a virtual machine. In some examples, applications or services accessing workloads for the dashboard light driver can also be moved to the virtual machine. Communication channels (e.g., sockets) can be established between the guest kernel and the host kernel to bring functionality of the isolated driver back to the host kernel. If the dashboard light driver fails, this can cause the virtual machine to fail. But, failure of the virtual machine may not be propagated to the host kernel, including to the headlight driver executed by the host kernel.

In the interest of clarity of explanation, embodiments described herein are discussed in relation to functional safety standards in the automotive industry. Embodiments of the present disclosure may similarly and equivalently apply to any system with drivers in which isolating some drivers due to differing levels of privilege, access, certification, and the like is beneficial.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

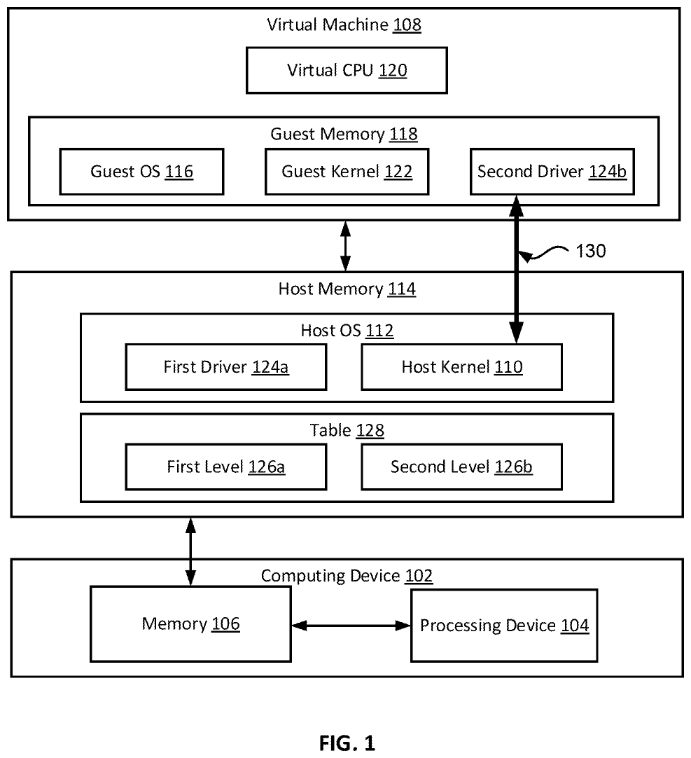

FIG. 1 is a block diagram of an example of a monolithic operating system in a computing device 102 for isolating drivers using virtualization according to some aspects of the present disclosure. Examples of the computing device 102 can include a desktop computer, laptop computer, server, mobile phone, tablet, electronic control units, or any other suitable type of computing device, such as any computing device incorporated into an automotive vehicle. The computing device 102 can include a processing device 104 communicatively coupled to the memory 106 to perform operations based on instructions in the memory 106. Additionally, the computing device 102 can run a virtual machine 108 by executing a host kernel 110 and a host operating system (OS) 112 in host memory 114. The host OS 112 can have a monolithic kernel architecture such that the host OS 112 runs in kernel space. In some examples, the virtual machine 108 can be a kernel-based virtual machine, where the host kernel 110 functions as a hypervisor. The host kernel 110 may run as a bare metal instance. Examples of monolithic kernel architecture can include Unix and Linux.

The host kernel 110 can virtualize a physical layer of the computing device 102, including processors, memory devices, input/output devices, memory management devices, and the like and present this virtualization to the virtual machine 108 as devices, including virtual processors, virtual memory devices, virtual input/output devices, virtual memory management devices, and the like. The virtual machine 108 may run any type of dependent, independent, or compatible applications on the underlying hardware and host OS 112. In this example, the virtual machine 108 is executing a guest OS 116 that resides in guest memory 118, which may utilize underlying hardware (e.g., a virtual central processing unit (vCPU) 120) to run software. The guest OS 116 can additionally include or execute a guest kernel 122 responsible for performing operations of the guest OS 116.

The computing device 102 may execute drivers 124a-b that include one or more files that enable hardware in the computing device 102 to communicate with the host OS 112. If the computing device 102 is part of an automotive vehicle, the drivers 124a-b may be associated with hardware for headlights, taillights, brakes, display systems, radio systems, or other components of the automotive vehicle. For example, a first driver 124a may execute workloads related to controlling headlights in an automotive vehicle. A second driver 124b may execute workloads related to operating a radio system in the automotive vehicle.

Execution of some drivers in the computing device 102 may be more critical or essential than others. For example, each driver may have different permission levels, access levels, ratings, risk classifications, and the like. In embodiments relating to automotive vehicles, each driver may have a functional safety rating (e.g., Automotive Safety Integrity Level (ASIL) A, ASIL B, ASIL C, ASIL D, or Quality Management (QM)) as part of the International Organization for Standardization (ISO) 26262 classifications for inherent safety risk in an automotive system. Each functional safety rating (e.g., level of criticality) can indicate degrees of hazards related to failure of the associated driver. In some examples, the first driver 124a executing workloads related to headlights may have first level 126a of criticality of ASIL B, which may be higher than the second level 126b of criticality of QM for radio workloads for the second driver 124b. In some examples, the host kernel 110 can determine a level of criticality for the drivers 124a-b by accessing a look-up table 128.

Because monolithic kernel architecture typically involves executing processes in a single kernel space, it may be important to ensure that failure of the second driver 124b controlling the radio system does not cause failure of more important systems such as the second driver 124b controlling the headlights. Conventionally, executing ASIL B level drivers may involve using a microkernel that can isolate the ASIL B level drivers from drivers of other levels, or using a separate computing system for ASIL B level drivers and drivers of other levels (e.g., OM). Embodiments described herein can allow for drivers with various criticality levels to be executed by the same computing system and with a monolithic kernel architecture by isolating the second driver 124b with the lower criticality level in the virtual machine 108.

The virtual machine 108 may be a virtualization of the monolithic kernel architecture of the host system, with the guest kernel 122 as a guest monolithic kernel. Upon detecting that the second level 126b of criticality for the second driver 124b is lower than the first level 126a of criticality for the first driver 124a, the host kernel 110 can pass device ownership for the second driver 124b to the virtual machine 108. The guest kernel 122 may run in isolation from the host kernel 110. Thus, failure of the guest kernel 122 may not affect the host kernel 110.

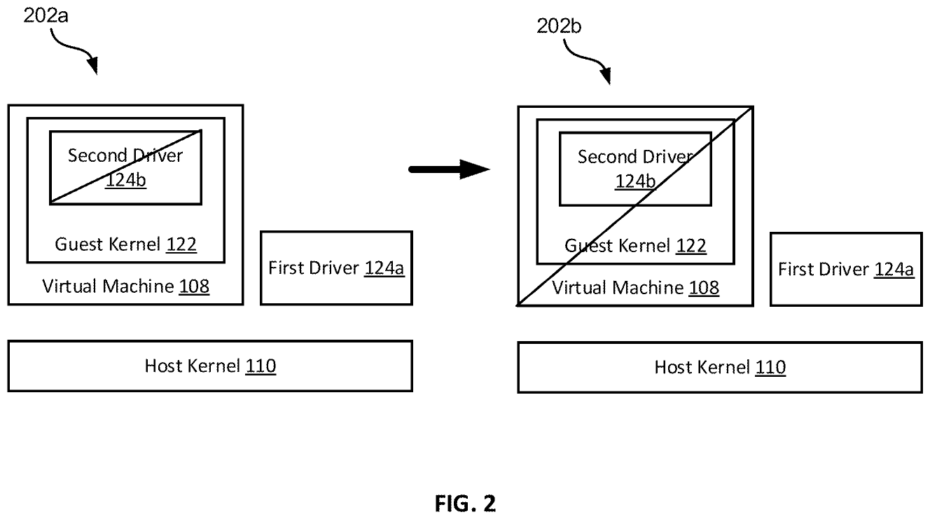

This is depicted in FIG. 2, which illustrates a flow diagram of an example of a monolithic operating system for isolating drivers using virtualization according to some aspects of the present disclosure. The guest kernel 122 can execute the second driver 124b that is isolated in the virtual machine 108 (e.g., in its own virtualized kernel space that is isolated from the host kernel 110). The host kernel 110 may be functioning as a hypervisor for the virtual machine 108. The host kernel 110 may also be executing the first driver 124a (e.g., in kernel space). As depicted in FIG. 2, at a first time 202a, the second driver 124b can experience a failure. Because the second driver 124b is isolated in the virtual machine 108 (e.g., does not have access to kernel space for the host kernel 110), at a second time 202b the failure of the second driver 124b may be isolated to the virtual machine 108. That is, the first driver 124a and the host kernel 110 may not experience failure due to the failure of the second driver 124b.

Referring back to FIG. 1, although the second driver 124b may be isolated to the virtual machine 108, functionalities of the second driver 124b may be exposed back to the host kernel 110 via a communication channel 130. In some examples, the communication channel 130 may be a socket, such as a socket passthrough virtual device, for the virtual machine 108. In some examples, the communication channel 130 may be exposed using virtio-vsock protocol. The host kernel 110 (or, in some examples, the host kernel 110 executing the first driver 124a or any other process or application) can send workload requests to the second driver 124b and receive responses via the communication channel 130. This can allow the computing device 102 to have the benefits of running a bare metal instance of the host kernel 110 and protecting the host kernel 110 from failure of the second driver 124b while still making use of functions for the second driver 124b.

While FIG. 1 depicts a specific arrangement of components, other examples can include more components, fewer components, different components, or a different arrangement of the components shown in FIG. 1. For instance, in other examples, the computing device 102 may include any number of drivers or virtual machines. Each virtual machine may isolate any number of drivers from the host kernel 110. Additionally, any component or combination of components in FIG. 1 can be used to implement the processes described herein.

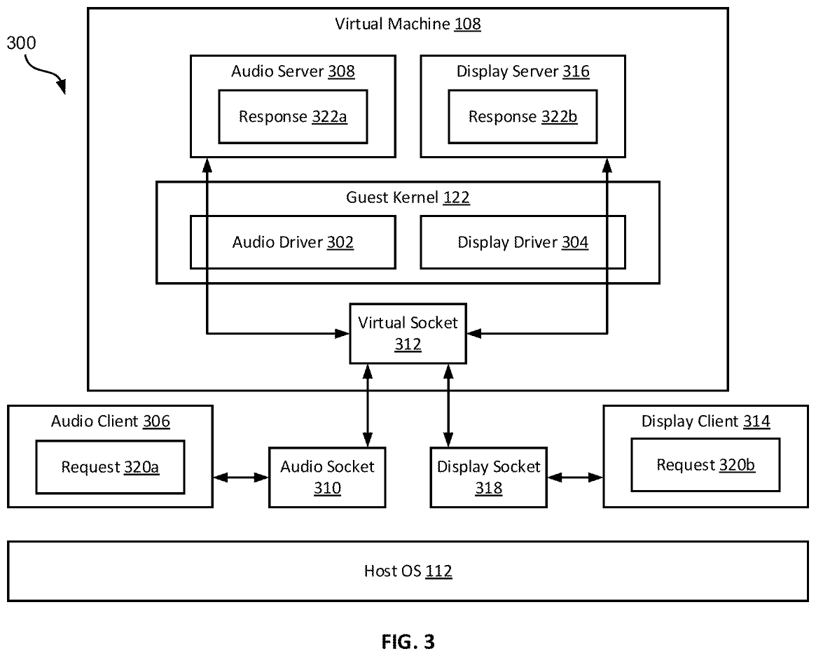

FIG. 3 is a block diagram of an example of an automotive computing environment 300 with a monolithic kernel architecture that isolates drivers using virtualization according to some aspects of the present disclosure. The automotive computing environment 300 can include a host OS 112 executing a virtual machine 108 that includes a guest kernel 122 (e.g., the host OS 112, virtual machine 108, and guest kernel 122 of FIG. 1). The automotive computing environment 300 can include an audio driver 302 and a display driver 304. The audio driver 302 may involve functions that output or capture audio, such as for a radio system in an automotive vehicle. The display driver 304 may involve functions that control a graphical user interface of an instrument display for the automotive vehicle. The display driver 304 and the audio driver 302 can each be isolated to the virtual machine 108 so that their failure does not cascade to other processes executed by the host OS 112.

Functionality of the display driver 304 and the audio driver 302 can be exposed back to the host OS 112. In some examples, this may involve a client-server architecture for the drivers. For example, an audio application may utilize the audio driver 302 to perform radio functions. The audio application can include one or more audio clients 306 executed by the host OS 112 or a host kernel (e.g., host kernel 110 of FIG. 1) and an audio server 308 executed by the guest kernel 122 of the virtual machine 108. The audio client 306 can use a audio socket 310 to communicate with the audio server 308 that uses the audio driver 302. In some examples, the audio socket 310 can be exposed using virtio-vsock protocol with virtual socket 312, which is a socket passthrough virtual device. This can allow audio clients 306 on the host OS 112 to perform functions with the audio driver 302 (e.g., outputting audio, capturing an audio stream from a microphone, or any other radio functions) without requiring a audio driver in the host OS 112. For example, the audio client 306 can generate a first request 320a that is passed through to the audio server 308 via the audio socket 310 and the virtual socket 312. The audio server 308 can generate a first response 322a to the first request 320a from workload for the audio driver 302. The first response 322a can be passed through to the audio client 306 via the virtual socket 312 and the audio socket 310.

Similarly, a display application may utilize the display driver 304 to generate and display the graphical user interface. The display application may include one or more display clients 314 executed by the host OS 112 or host kernel 110 and a display server 316 executed by the guest kernel 122 of the virtual machine 108. The display client 314 can use a display socket 318 to communicate with the display server 316 that uses the display driver 304. In some examples, the display socket 318 can be exposed suing virtio-vsock protocol with virtual socket 312. This can allow display clients 314 on the host OS 112 to render the graphical user interface using functions of the display driver 304. For example, the display client 314 may generate a second request 320b that is passed through to the display server 316 via the display socket 318 and the virtual socket 312. The display server 316 can generate a second response 322b to the second request 320b based on workload for the display driver 304. The second response 322b can be passed through to the display client 314 via the virtual socket 312 and the display socket 318. In some examples, a display client 314 may use a software renderer that using a CPU to render graphical content, as the display driver 304 may not be executed by the host OS 112.

Although examples herein are described with reference to audio drivers and display drivers in automotive computing environments, in other examples techniques described herein may be applied to any type of driver for any type of device.

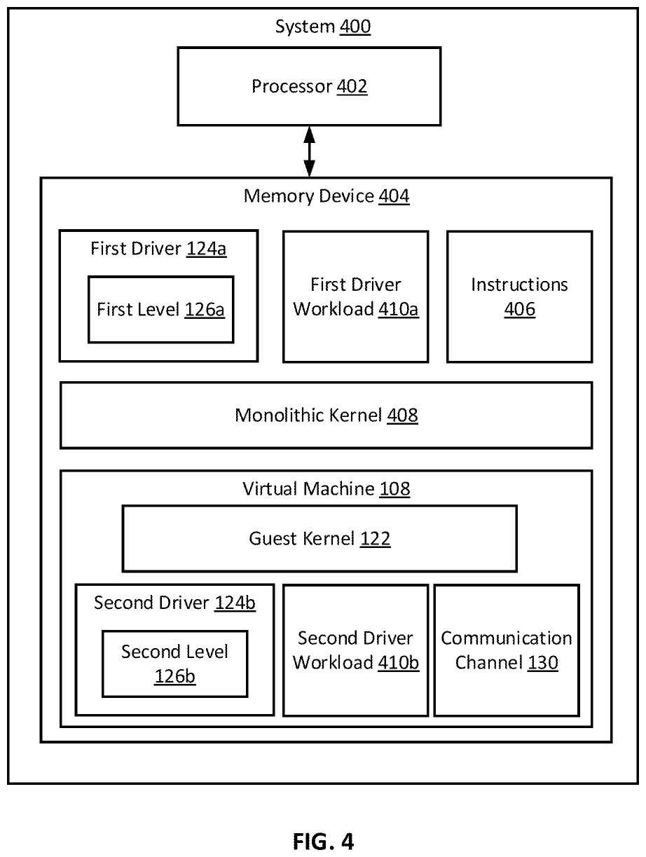

FIG. 4 is a block diagram of another example of a monolithic operating system for isolating drivers using virtualization according to some aspects of the present disclosure. A computing environment 400 can include a processing device 402 communicatively coupled to a memory device 404. In some examples, the processing device 202 can be the processing device 104 of FIG. 1. Similarly, the memory device 404 may be the host memory 114 of FIG. 1.

The processing device 402 can include one processing device or multiple processing devices. The processing device 402 can be referred to as a processor. Non-limiting examples of the processing device 402 include a Field-Programmable Gate Array (FPGA), an application-specific integrated circuit (ASIC), and a microprocessor. The processing device 402 can execute instructions 406 stored in the memory device 404 to perform operations. In some examples, the instructions 406 can include processor-specific instructions generated by a compiler or an interpreter from code written in any suitable computer-programming language, such as C, C++, C#, Java, Python, or any combination of these.

The memory device 404 can include one memory device or multiple memory devices. The memory device 404 can be non-volatile and may include any type of memory device that retains stored information when powered off. Non-limiting examples of the memory device 404 include electrically erasable and programmable read-only memory (EEPROM), flash memory, or any other type of non-volatile memory. At least some of the memory device 404 includes a non-transitory computer-readable medium from which the processing device 202 can read instructions 406. A computer-readable medium can include electronic, optical, magnetic, or other storage devices capable of providing the processing device 402 with the instructions 406 or other program code. Non-limiting examples of a computer-readable medium include magnetic disk(s), memory chip(s), ROM, random-access memory (RAM), an ASIC, a configured processor, and optical storage.

In some examples, the processing device 402 can include a monolithic kernel 408, which may be an example of host kernel 110 of FIGS. 1-2. The processing device 402 can execute the monolithic kernel 408 to determine that a first driver 124a has a first level 126a of criticality to the monolithic kernel 408 that is higher than a second level 126b of criticality for a second driver 124b. In response to determining that the first level 126a of criticality is higher than the second level 126b of criticality, the processing device 402 can configure the monolithic kernel 408 to execute a first driver workload 410a for the first driver 124a. The processing device 402 can also execute a virtual machine 108 with a guest kernel 122 that can execute a second driver workload 410b for the second driver 124b. The second driver 124b can be isolated to the virtual machine 108. The processing device 402 can generate a communication channel 130 between the guest kernel 122 and the monolithic kernel 408. The monolithic kernel 408 can access the second driver workload 410b via the communication channel 130.

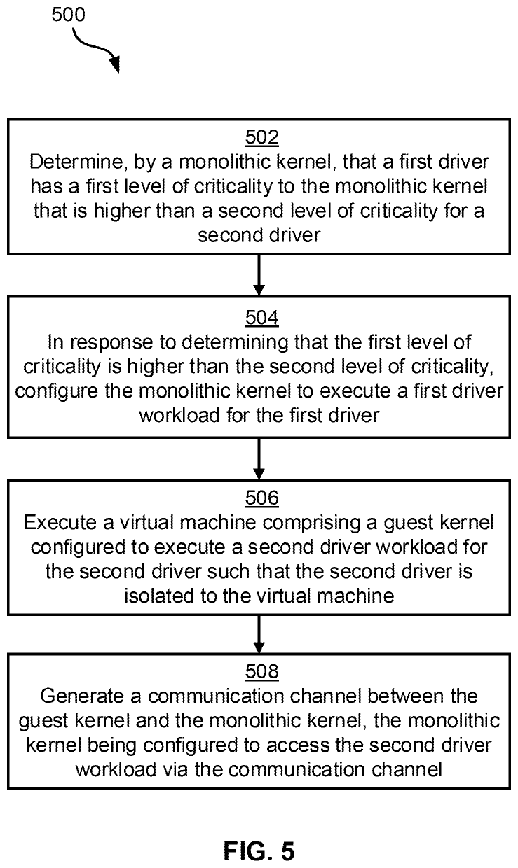

FIG. 5 is a flow chart of an example of a process 500 for isolating drivers using virtualization in a monolithic operating system according to some aspects of the present disclosure. In some examples, the processing device 402 can perform one or more of the steps shown in FIG. 5. In other examples, the processing device 402 can implement more steps, fewer steps, different steps, or a different order of the steps depicted in FIG. 5. The steps of FIG. 5 are described below with reference to components discussed above in FIGS. 1-4.

At block 502, the processing device 402 can execute a monolithic kernel 408 to determine that a first driver 124a has a first level 126a of criticality to the monolithic kernel 408 that is higher than a second level 126b of criticality for a second driver 124b. The monolithic kernel 408 may be executing as a bare metal instance of a computing environment, such as an automotive computing environment. The levels of criticality may be predetermined for each of the drivers 124a-b. In this example, the first driver 124a may have a first level 126a of criticality associated with an ASIL D classification under ISO 26262. The first driver 124a may perform functions used in controlling braking for an automotive vehicle. The second driver 124b may have a second level 126b of criticality associated with an ASIL A classification under ISO 26262. The second driver 124b may perform functions used in heating or cooling the automotive vehicle. Thus, it may be highly important to prevent heating or cooling issues with second driver 124b from affecting the braking of the automotive vehicle.

At block 504, in response to determining that the first level 126a of criticality is higher than the second level 126b of criticality, the processing device 402 can configure the monolithic kernel 408 to execute a first driver workload 410a for the first driver 124a. The monolithic kernel 408 may directly execute the first driver workload 410a by using the first driver 124a in kernel space. If the braking fails, heating or cooling the automotive vehicle may not be important to the safety of a user operating the automotive vehicle (e.g., relative to hazards associated with failed braking). But, if the heating or cooling fails, it may still be highly important to properly perform braking functions. Therefore, the first driver 124a may be executed by the monolithic kernel 408 because the first driver 124a may be the most safety critical driver.

At block 506, the processing device 402 can execute a virtual machine 108 comprising a guest kernel 122 configured to execute a second driver workload 410b for the second driver 124b such that the second driver 124b is isolated to the virtual machine 108. In some examples, the virtual machine 108 can be a kernel-based virtual machine, with the monolithic kernel 408 configured as a hypervisor for the kernel-based virtual machine. This can allow any failures of the second driver 124b to be isolated to the virtual machine 108 instead of being propagated to kernel space for the monolithic kernel 408. For example, the virtual machine 108 may not have access to memory addresses in the kernel space that are not allocated to the virtual machine 108. The other memory addresses in the kernel space may therefore be isolated from any failure of the virtual machine 108.

At block 508, the processing device 402 can generate a communication channel 130 between the guest kernel 122 and the monolithic kernel 408. The monolithic kernel 408 can be configured to access the second driver workload 410b via the communication channel 130. In some examples, the communication channel can be a socket, such as a socket between the second driver 124b (or another service using the second driver 124b) and the monolithic kernel 408 or any services executed by the host operating system for the automotive computing system. This can allow the second driver workload 410b to be exposed to the monolithic kernel 408 while protecting the monolithic kernel 408.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any example(s) described herein can be combined with any other example(s) to yield further examples.

1. A system comprising:
a processing device; and
a memory comprising instructions that are executable by the processing device for causing the processing device to:
determine, by a monolithic kernel, that a first driver has a first level of criticality to the monolithic kernel that is higher than a second level of criticality for a second driver; and
in response to determining that the first level of criticality is higher than the second level of criticality:
configure the monolithic kernel to execute a first driver workload for the first driver;
execute a virtual machine comprising a guest kernel configured to execute a second driver workload for the second driver such that the second driver is isolated to the virtual machine; and
generate a communication channel between the guest kernel and the monolithic kernel, the monolithic kernel being configured to access the second driver workload via the communication channel.

2. The system of claim 1, wherein the communication channel is a socket, and wherein the memory further comprises instructions that are executable by the processing device for causing the processing device to:
receive, by the second driver via the socket, a workload request from a client application executed by the monolithic kernel;
generate, by the second driver, a response to the workload request based on the second driver workload; and
transmit the response to the client application via the socket.

3. The system of claim 1, wherein a failure of the second driver executed by the guest kernel is isolated to the virtual machine.

4. The system of claim 1, wherein the virtual machine is a kernel-based virtual machine, and wherein the monolithic kernel is configured as a hypervisor for the kernel-based virtual machine.

5. The system of claim 1, wherein the first level is an Automotive Safety Integrity Level (ASIL) and the second level is a Quality Management (QM) level for an automotive computing environment that comprises the monolithic kernel.

6. The system of claim 1, wherein the second driver is a display driver or an audio driver in an automotive computing environment.

7. The system of claim 1, wherein the monolithic kernel executes as a bare metal instance of a computing environment.

8. A method comprising:
determining, by a processing device executing a monolithic kernel, that a first driver has a first level of criticality to the monolithic kernel that is higher than a second level of criticality for a second driver; and
in response to determining that the first level of criticality is higher than the second level of criticality:
configuring, by the processing device, the monolithic kernel to execute a first driver workload for the first driver;
executing, by the processing device, a virtual machine comprising a guest kernel configured to execute a second driver workload for the second driver such that the second driver is isolated to the virtual machine; and
generating, by the processing device, a communication channel between the guest kernel and the monolithic kernel, the monolithic kernel being configured to access the second driver workload via the communication channel.

9. The method of claim 8, wherein the communication channel is a socket, and wherein the method further comprises:
receiving, by the second driver via the socket, a workload request from a client application executed by the monolithic kernel;
generating, by the second driver, a response to the workload request based on the second driver workload; and
transmitting the response to the client application via the socket.

10. The method of claim 8, wherein a failure of the second driver executed by the guest kernel is isolated to the virtual machine.

11. The method of claim 8, wherein the virtual machine is a kernel-based virtual machine, and wherein the monolithic kernel is configured as a hypervisor for the kernel-based virtual machine.

12. The method of claim 8, wherein the first level is an Automotive Safety Integrity Level (ASIL) and the second level is a Quality Management (QM) level for an automotive computing environment that comprises the monolithic kernel.

13. The method of claim 8, wherein the second driver is a display driver or an audio driver in an automotive computing environment.

14. The method of claim 8, wherein the monolithic kernel executes as a bare metal instance of a computing environment.

15. A non-transitory computer-readable medium comprising program code that is executable by a processing device for causing the processing device to:
determine, by a monolithic kernel, that a first driver has a first level of criticality to the monolithic kernel that is higher than a second level of criticality for a second driver; and
in response to determining that the first level of criticality is higher than the second level of criticality:
configure the monolithic kernel to execute a first driver workload for the first driver;
execute a virtual machine comprising a guest kernel configured to execute a second driver workload for the second driver such that the second driver is isolated to the virtual machine; and
generate a communication channel between the guest kernel and the monolithic kernel, the monolithic kernel being configured to access the second driver workload via the communication channel.

16. The non-transitory computer-readable medium of claim 15, wherein the communication channel is a socket, and wherein the program code is further executable by the processing device for causing the processing device to:
receive, by the second driver via the socket, a workload request from a client application executed by the monolithic kernel;
generate, by the second driver, a response to the workload request based on the second driver workload; and
transmit the response to the client application via the socket.

17. The non-transitory computer-readable medium of claim 15, wherein a failure of the second driver executed by the guest kernel is isolated to the virtual machine.

18. The non-transitory computer-readable medium of claim 15, wherein the virtual machine is a kernel-based virtual machine, and wherein the monolithic kernel is configured as a hypervisor for the kernel-based virtual machine.

19. The non-transitory computer-readable medium of claim 15, wherein the first level is an Automotive Safety Integrity Level (ASIL) and the second level is a Quality Management (QM) level for an automotive computing environment that comprises the monolithic kernel.

20. The non-transitory computer-readable medium of claim 15, wherein the second driver is a display driver or an audio driver in an automotive computing environment.
